(19) United States
(12) Patent Application Publication
(10) Pub. No.: US 2023/0021732 A1
(43) Pub. Date: Jan. 26, 2023

(54) CONTROL PANEL DISPLAY WITH ROTATABLE MOUNT

(71) Applicant: HEWLETT-PACKARD DEVELOPMENT COMPANY, L.P., Spring, TX (US)

(72) Inventors: Josiah RADCLIFFE, Boise, ID (US); Alan WILLIAMSON, Boise, ID (US)

(73) Assignee: HEWLETT-PACKARD DEVELOPMENT COMPANY, L.P., Spring, TX (US)

(21) Appl. No.: 17/787,443

(22) PCT Filed: Dec. 20, 2019
(86) PCT No.: PCT/US2019/067920

§ 371 Date: Jun. 20, 2022

(51) Int. Cl. H04N 1/00; B41J 29/06; B41J 29/04

(52) U.S. Cl. CPC H04N 1/00496; B41J 29/06; B41J 29/04

(57) ABSTRACT

Examples of the present disclosure are directed toward a control panel display with rotatable mount. An example apparatus includes a control panel mount including a first surface to receive a control panel display and a second surface opposite the first surface. The apparatus further includes a rotatable mount including a first surface and a second surface opposite the first surface. A first hinge mechanism which is rotatable about a first axis may allow the rotatable mount to move between a first operational position in which the rotatable mount is disposed in contiguous contact with a top cover of the apparatus and a second operational position in which the control panel display is disposed within a recessed portion of the top cover. A second hinge mechanism may be rotatable about a second axis orthogonal to the first axis to change a display angle of the control panel display.

### BACKGROUND

Electronic appliances including office machines such as printers or copiers may include a display unit to visually provide a user with information about the operational status and control of the appliance. A display unit may be installed at a fixed angle of inclination on a body of the electronic appliance. Alternatively, the display unit may be installed on the body of the electronic appliance such that a user can control the inclination angle to improve convenience of storage, transport, and use.

### BRIEF DESCRIPTION OF THE DRAWINGS

FIG. 1A illustrates an example apparatus including a control panel display with a rotatable mount, consistent with the present disclosure.

FIG. 1B illustrates an example apparatus including a control panel display with a rotatable mount, consistent with the present disclosure.

FIG. 1C further illustrates aspects of an example top cover to receive a control panel display with a rotatable mount, consistent with the present disclosure.

FIG. 1D further illustrates an exploded view of an example control panel mount and rotatable mount, consistent with the present disclosure.

FIG. 2A illustrates an additional example apparatus including a control panel display with a rotatable mount, consistent with the present disclosure.

FIG. 2B further illustrates axes of rotation of an example control panel display with a rotational mount, consistent with the present disclosure.

FIG. 3A illustrates an example rotating control panel in a first operational position, consistent with the present disclosure.

FIG. 3B illustrates a side view of an example apparatus in the first operational position, consistent with the present disclosure.

FIG. 3C illustrates an example of a rotating control panel in the second operating position, consistent with the present disclosure.

FIG. 3D illustrates a side view of the apparatus 300 in the second operating position, consistent with the present disclosure.

FIG. 4 illustrates an example flow diagram of an example apparatus moving from the second operational position to the first operational position.

### DETAILED DESCRIPTION

A control panel on a device, including a printing device, may be mounted on the top of the apparatus. This causes the control panel to extend beyond the plane of the top cover of the apparatus, which may result in an increase in packaging size and cost. Additionally, customers may desire to stack unboxed apparatuses on top of each other for storage. The mounting configuration of the control panel may prohibit this type of stacking.

In accordance with examples of the present disclosure, the control panel of an apparatus may rotate to be stored below the top surface of the apparatus for packaging and storage. The control panel mount may also rotate to be positioned on the top cover of the apparatus. This allows a product configuration with a minimized profile for shipping while also providing a second configuration for improved viewing and functionality during use.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

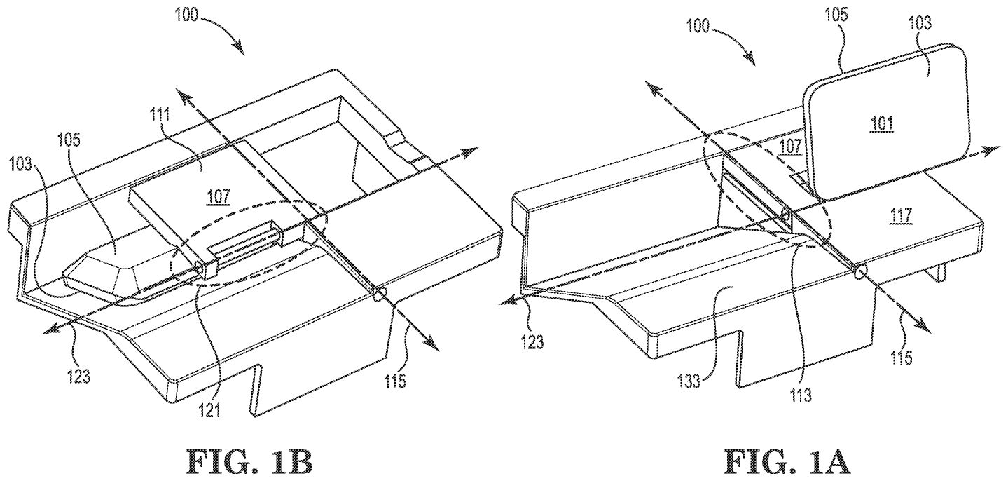

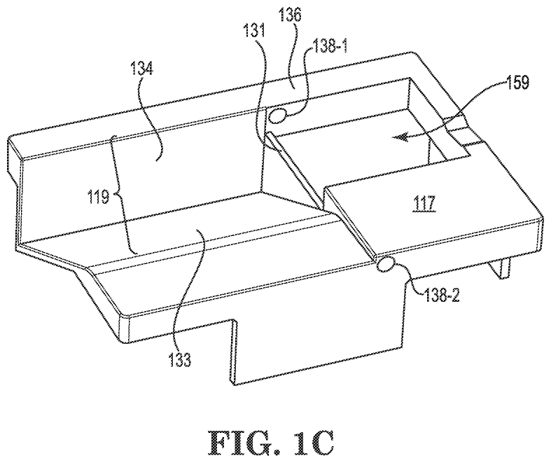

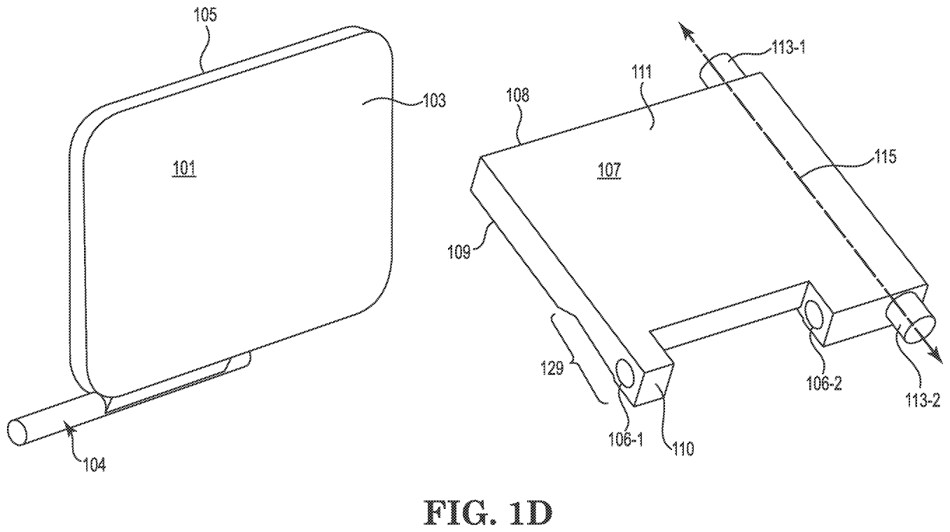

Turning now to the Figures, FIGS. 1A and 1B illustrate an example apparatus including a control panel display with a rotatable mount, consistent with the present disclosure. Particularly, FIG. 1A illustrates an apparatus 100, including a control panel mount 101 and a rotatable mount 107 displayed in a first operational position, and FIG. 1B illustrates the example apparatus 100 including a control panel mount 101 and a rotatable mount 107 displayed in a second operational position. Each of the first operational position and the second operational position will now be discussed.

In various examples, the control panel mount 101 includes a first surface 103 to receive a control panel display and a second surface 105 opposite the first surface 103. The control panel display may include a liquid-crystal display (LCD), a light-emitting diode display (LED), an organic light-emitting diode display, and/or other types of input/output devices for presentation of information from the apparatus 100 in visual and/or tactile form.

The control panel mount 101 and the rotatable mount 107 may rotate to adjust the orientation of the control panel display. For instance, the apparatus 100 may include a first hinge mechanism 113 rotatable about a first axis 115 to allow the rotatable mount 107 to move between a first operational position (illustrated in FIG. 1A) in which the rotatable mount 107 is disposed in contiguous contact with a top cover 117 of the apparatus and a second operational position (illustrated in FIG. 1B) in which the control panel display is disposed within a recessed portion of the top cover 117. Similarly, the apparatus 100 may include a second hinge mechanism 121 rotatable about a second axis 123 orthogonal to the first axis 115 to change a display angle of the control panel display. While the first axis and the second axis are described herein as being orthogonal to one another, examples are not so limited. The first axis and the second axis may be at angles greater than or less than 90 degrees.

FIG. 1C further illustrates aspects of an example top cover to receive a control panel display with a rotatable mount, consistent with the present disclosure. The housing of the apparatus 100 may include a plurality of surfaces to support the control panel mount 101 and rotatable mount 107 in the plurality of operational positions. For instance, when the rotatable mount 107 is parallel to the top cover 117 in the first operational position, a surface 131 may apply a resistive force to the rotatable mount 107. That is, the rotatable mount 107 may be prohibited from rotating beyond a particular plane as a result of a resistive force applied by surface 131 and/or other components of the top cover 117. Additionally, the top cover 117 of the apparatus includes an angled plane 133 to apply a resistive force to the control panel display in the second operational position.

The top cover 117 may include a plurality of components. For instance, the top cover 117 may include a planar surface 136 which comprises a top surface of the apparatus 100. The top cover 117 may further include a recessed portion 119. The recessed portion 119 may be defined by a vertical surface 134 which is orthogonal to the planar surface 136, and an angled plane 133 which extends from the planar surface 136 to the vertical surface 134 at a particular angle such that the control panel mount may be received in the second operational position.

As discussed with regards to FIG. 1B, the apparatus 100 may include a first hinge mechanism 113 rotatable about a first axis 115 to allow the rotatable mount 107 to move between a first operational position in which the rotatable mount 107 is disposed in contiguous contact with a top cover 117 of the apparatus and a second operational position in which the control panel display is disposed within the recessed portion 119. For instance, to facilitate rotation of the first hinge mechanism 113 about first axis 115, hinge pin receptacle 138-1 and hinge pin receptacle 138-1 may receive hinge pins of the rotatable mount (as discussed further in relation to FIG. 1D).

FIG. 1D further illustrates an exploded view of an example control panel mount and rotatable mount, consistent with the present disclosure. A rotatable mount 107 may be coupled to the control panel mount 101. As illustrated in FIGS. 1A and 1B, the rotatable mount 107 includes a first surface 109 and a second surface 111 opposite the first surface 109. Each of the control panel mount 101 and the rotatable mount 107 may include components to allow the rotatable mount 107 to move between a first operational position in which the rotatable mount 107 is disposed in contiguous contact with a top cover 117 of the apparatus and a second operational position in which the control panel display is disposed within the recessed portion 119. For instance, the rotatable mount 107, may include a first hinge pin 113-1 and a second hinge pin 113-2. Collectively, the first hinge pin 113-1 and the second hinge pin 113-2 may comprise the hinge mechanism 113, though examples are not so limited. Additional and/or different types of hinge mechanisms may be used, as discussed further herein. The first hinge pin 113-1 and the second hinge pin 113-2 may be arranged on a third side 108 of rotatable mount 107 and a fourth side 110 of rotatable mount 107, such that the rotatable mount 107 may rotate about axis 115. For instance, the rotatable mount 107 includes a third surface 108 orthogonal to the first surface 109 and the second surface 111, and a fourth surface 110 opposite the third surface 108 and orthogonal to the first surface 109 and the second surface 111, the third surface 108 including a first hinge pin 113-1 and the fourth surface 110 including a second hinge pin 113-2.

Moreover, the first surface 109 of the rotatable mount 107 may include a concave depression 129 to receive the second surface of the control panel mount in the second operational position. The rotatable mount 107 may include a depression of different and/or additional shapes, other than a concave depression as illustrated.

Additionally, the rotatable mount 107 may include components to receive a hinge mechanism of the control panel mount 101. As illustrated in FIG. 1D, rotatable mount 107 may include a hinge pin receptacle 106-2 which is proximal to the hinge pin 113-2, and a hinge pin receptacle 106-1 which is distal to the hinge pin 113-2. Collectively, hinge pin receptacle 106-1 and 106-2 may couple with hinge pin 104 of the control panel mount 101. Each of hinge pin receptacle 106-1 and 106-2 may receive an opposing side of hinge pin 104, as illustrated in FIGS. 1A and 1B.

The control panel mount and the rotatable mount may rotate in various directions, such that the apparatus 100 can be in a plurality of operational positions. For instance, the rotatable mount 107 may fixedly attach to the top cover 117 of the apparatus 100 in the first operational position. In various examples, the rotatable mount 107 may fasten to the top cover 117, such as with a clip, latch, or other securing mechanism. The rotatable mount and control panel mount may be rotatable in a plurality of directions. As a further illustration, the rotatable mount 107 may be rotatable about an axis 115 via the first hinge pin 113-1 and the second hinge pin 113-2. Similarly, the rotatable mount 107 may be rotatable about a first axis 115 and the control panel mount 101 is rotatable about a second axis 123 orthogonal to the first axis 115.

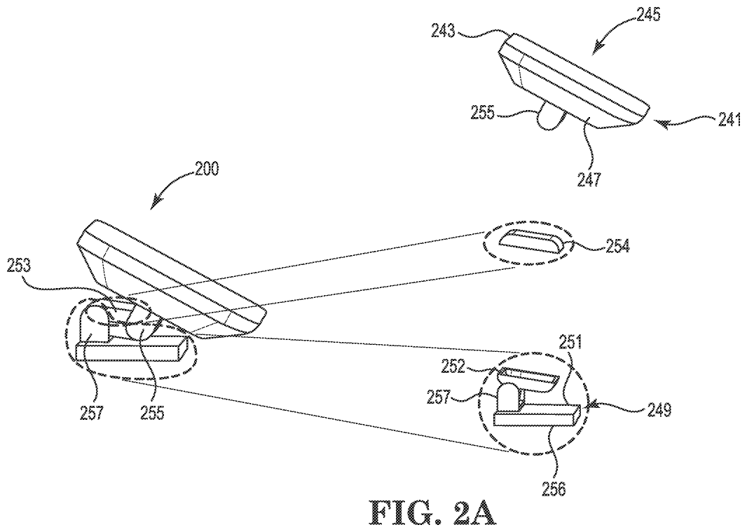

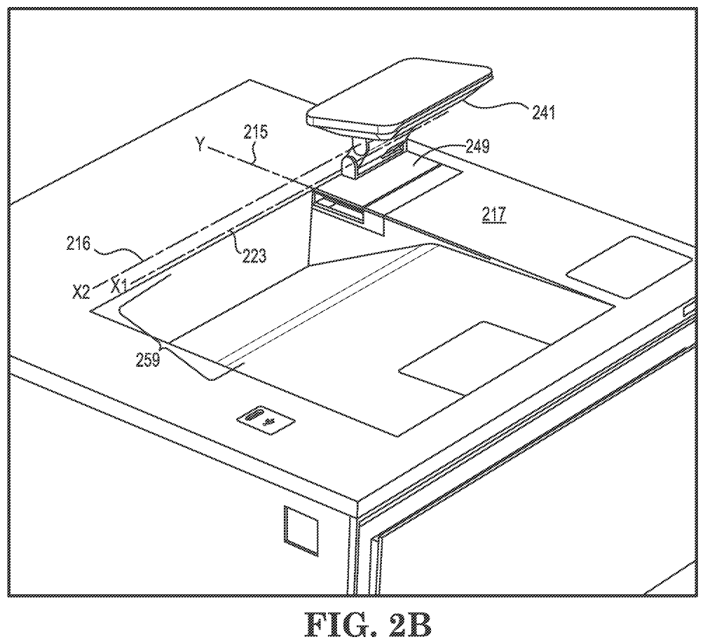

FIG. 2A illustrates an additional example apparatus 200 including a control panel display with rotatable mount, consistent with the present disclosure. As is illustrated in FIG. 2A, the control panel mount may couple to the rotatable mount in different and/or additional ways. As an example, the control panel mount may include a linkage arm 253 coupling the control panel mount 241 and the rotatable mount 249. This linkage arm 253 may provide for greater flexibility and a greater number of angles of viewing the control panel display. For instance, referring to FIG. 2A, the apparatus 200 may include a control panel mount 241 including a first surface 243 to receive a control panel display 245 and a second surface 247 opposite the first surface 243. Additionally, the apparatus 200 may include a rotatable mount 249 including a first surface 251 and a second surface 256 opposite the first surface 251. The rotatable mount may be the same and/or like the rotatable mount illustrated and described with regards to FIGS. 1A-1D. Moreover, the control panel display 245 may be the same and/or like the control panel display illustrated with regards to FIGS. 1A-1D.

The linkage arm 253 may include a plurality of components which facilitate rotation of the control panel mount 241 relative to the rotatable mount 249. For instance, the linkage arm 253 may include a first hinge unit 255 coupling the linkage arm 253 to the second surface 247 of the control panel mount 241, and a second hinge unit 257 coupling the linkage arm 253 to the first surface 251 of the rotatable mount 249. As such, the linkage arm 253 may extend away from the rotatable mount 249 to expand the distance between the control panel mount 241 and the rotatable mount 249, and/or rotate towards the rotatable mount 249 to reduce the distance between the control panel mount 241 and the rotatable mount 249. The linkage arm may include a plurality of components, such as a top layer 254 and a bottom layer 252. The top layer 254 and the bottom layer 252 may couple to form a single linkage arm with a hollow core. In various examples, each of the top layer 254 and the bottom layer 252 may define a side wall opening to facilitate passage of wiring therethrough.

FIG. 2B further illustrates axes of rotation for an example apparatus including a control panel mount with a rotational mount. In the example illustrated in FIG. 2B, the apparatus 200 is illustrated in the first operational position. As such, the second surface 256 of the rotatable mount 249 is fixedly attached to a top cover 217 of the apparatus 200 in a first operational position. As illustrated and discussed further herein, the control panel mount 241 may be disposed within a depressed region 259 of the top cover 217 in a second operational position.

In some examples, the rotatable mount 249 may include a third surface orthogonal to the first surface 251 and the second surface 256, and a fourth surface opposite the third surface and orthogonal to the first surface 251 and the second surface 256, the third surface including a first hinge pin and the fourth surface including a second hinge pin. The rotatable mount 249 may couple to, or otherwise be fixedly secured in top surface 217.

The rotatable mount and control panel mount may also be rotatable in a plurality of directions. For instance, the rotatable mount 107 may be rotatable about axis 215, such as via the first hinge pin 113-1 and the second hinge pin 113-2. Similarly, the rotatable mount 107 may be rotatable about a first axis 215 and the control panel mount 241 may be rotatable about a second axis 223 orthogonal to the first axis 215. In other words, the rotatable mount 249 may be rotatable about a first axis 215, and the control panel display 241 may be rotatable about a second axis 223 orthogonal to the first axis 215. The linkage arm 253 may be rotatable about a third axis 216 orthogonal to the first axis. As such, the rotatable mount 249 may securedly connect to the top cover 217, while the control panel display is to fixedly rotate relative to the linkage arm 253, and the linkage arm 253 is to fixedly rotate relative to the rotatable mount 249.

As an example, the apparatus 200 may be a printing apparatus. In this example, the rotatable mount 249 is rotatable about a first axis 215, the control panel display 241 is rotatable about a second axis 223 orthogonal to the first axis 215, and the linkage arm 253 is rotatable about a third axis 361 orthogonal to the first axis 215 to permit rotation of the control panel display 241 to a front side of the printing apparatus or a back side of the printing apparatus.

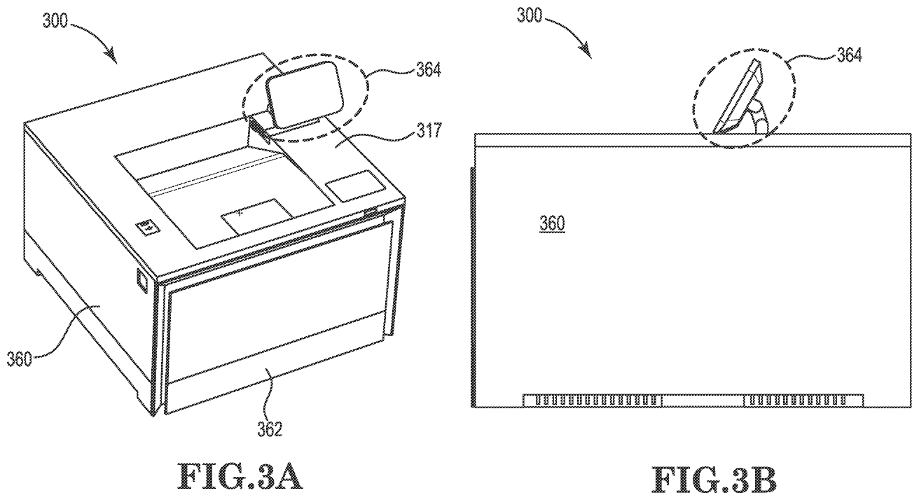

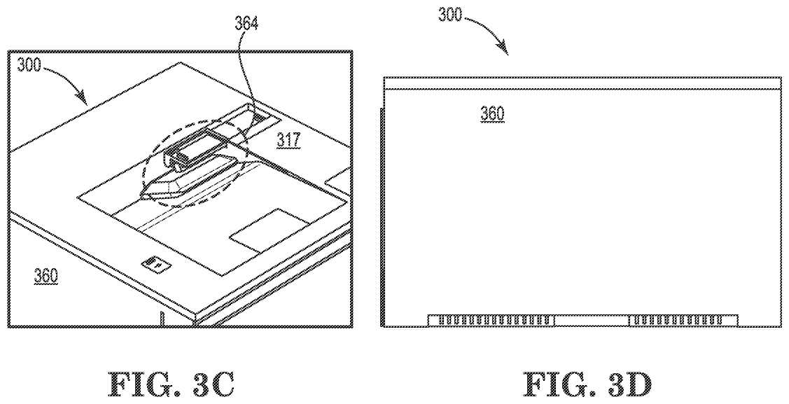

FIGS. 3A, 3B, 3C, and 3C further illustrate an example apparatus 300 including a control panel display with a rotatable mount in different operational positions, consistent with the present disclosure. In particular, FIG. 3A illustrates an apparatus 300 including a housing 360. The housing 360 may include a base surface 362 and a top cover 317. The top cover 317 may be disposed opposite to and parallel to the base surface 362.

The top cover 317 may include a first depressed region parallel to a plane of the top cover 317 to receive a rotating control panel 364 in a first operational position. As used herein, a rotating control panel refers to or includes a control panel mount and a rotating mount, as described herein. Referring to FIG. 1C, a first depressed region 159 may receive the rotating control panel as described herein. FIG. 3A illustrates the rotating control panel 364 in the first operational position. FIG. 3B illustrates a side view of the apparatus 300 in the first operational position, wherein the rotating control panel 364 extends above the top cover 317 of the apparatus.

As described herein, the top cover 317 may also include a second depression including an angled plane to receive the rotating control panel 364 in a second operational position. Again, referring to FIG. 1C, the recessed portion 119, including angled plane 133, may receive the rotating control panel 364 in the second operational position. FIG. 3C illustrates an example of the rotating control panel 364 in the second operating position. As illustrated, the rotating control panel is disposed within the second depressed region, such as recessed portion 119 illustrated in FIG. 1C. FIG. 3D illustrates a side view of the apparatus 300 in the second operating position, wherein the rotating control panel 364 does not extend above the top cover 317 of the apparatus.

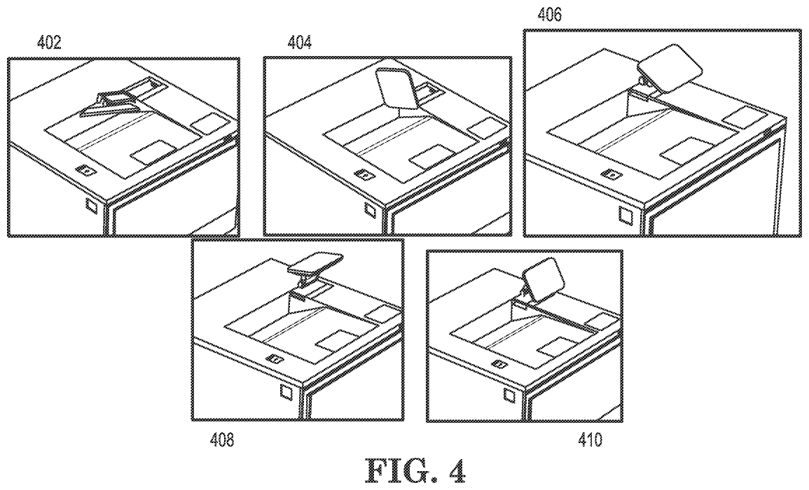

FIG. 4 illustrates an example flow diagram of an example apparatus 400 moving from the second operational position to the first operational position. As illustrated at 402, the rotating control panel (e.g., control panel mount with rotating mount) begins to transition from the second operational position. A user may lift the rotating control panel from the second depressed region (e.g., 119 illustrated in FIG. 1C) of the top cover (e.g., 117 illustrated in FIG. 1C). At 404, as the user rotates the rotating control panel out of the second depressed region, the rotating control panel rotates around a first hinge mechanism, such as hinge mechanism 113 illustrated in FIG. 1D. At 406, as the user rotates the rotating control panel completely out of the second depressed region, the rotating mount (e.g., 107 illustrated in FIGS. 1A and 1B) is disposed within a first depressed region, such as 159 illustrated in FIG. 1C. The rotating control panel may lock, latch, or otherwise fixedly secure within the first depressed region, and the apparatus 400 is disposed in the first operational position. At 408, the rotating control panel may articulate, such as along axis 261 illustrated in FIG. 2B, such that the control panel may direct the display in one of a plurality of directions along axis 261. For instance, 408 illustrates the rotating control panel oriented away from the top cover of the apparatus, whereas 410 illustrates the control panel oriented toward a front or back of the apparatus.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An apparatus including:
a control panel mount including a first surface to receive a control panel display and a second surface opposite the first surface;
a rotatable mount including a first surface and a second surface opposite the first surface;
a first hinge mechanism rotatable about a first axis to allow the rotatable mount to move between a first operational position in which the rotatable mount is disposed in contiguous contact with a top cover of the apparatus and a second operational position in which the control panel display is disposed within a recessed portion of the top cover; and
a second hinge mechanism rotatable about a second axis orthogonal to the first axis to change a display angle of the control panel display.

2. The apparatus of claim 1, wherein the rotatable mount is to fixedly attach to the top cover of the apparatus in the first operational position.

3. The apparatus of claim 1, wherein the first surface of the rotatable mount includes a concave depression to receive the second surface of the control panel mount in the second operational position.

4. The apparatus of claim 1, wherein a surface parallel to the top cover applies a resistive force to the rotatable mount in the first operational position.

5. The apparatus of claim 1, wherein the top cover of the apparatus includes an angled plane to apply a resistive force to the control panel display in the second operational position.

6. An apparatus including:
a control panel mount including a first surface to receive a control panel display and a second surface opposite the first surface;
a rotatable mount including a first surface and a second surface opposite the first surface; and
a linkage arm including a first hinge unit coupling the linkage arm to the second surface of the control panel mount, and a second hinge unit coupling the linkage arm to the first surface of the rotatable mount;
wherein the second surface of the rotatable mount is to fixedly attach to a top cover of the apparatus in a first operational position, and the control panel mount is disposed within a depressed region of the top cover in a second operational position.

7. The apparatus of claim 6, wherein the rotatable mount includes a third surface orthogonal to the first surface and the second surface, and a fourth surface opposite the third surface and orthogonal to the first surface and the second surface, the third surface including a first hinge pin and the fourth surface including a second hinge pin.

8. The apparatus of claim 7, wherein the rotatable mount is rotatable about an axis via the first hinge pin and the second hinge pin.

9. The apparatus of claim 6, wherein the rotatable mount is rotatable about a first axis and the control panel display is rotatable about a second axis orthogonal to the first axis.

10. The apparatus of claim 6, wherein the rotatable mount is rotatable about a first axis, the control panel display is rotatable about a second axis orthogonal to the first axis, and the linkage arm is rotatable about a third axis orthogonal to the first axis.

11. The apparatus of claim 10, wherein the rotatable mount is to securedly connect to the top cover, the control panel display is to fixedly rotate relative to the linkage arm, and the linkage arm is to fixedly rotate relative to the rotatable mount.

12. An apparatus comprising:
a housing including a base surface and a top cover opposite and parallel to the base surface, the top cover including:
a first depressed region parallel to a plane of the top cover to receive a rotating control panel in a first operational position; and
a second depression including an angled plane to receive the rotating control panel in a second operational position;
the rotating control panel including:
a control panel mount including a first surface to receive a control panel display and a second surface opposite the first surface; and
a rotatable mount including a first surface and a second surface opposite the first surface; and
a linkage arm including a first hinge unit coupling the linkage arm to the second surface of the control panel mount, and a second hinge unit coupling the linkage arm to the first surface of the rotatable mount;
wherein the second surface of the rotatable mount is to fixedly attach within the first depressed region in the first operational position, and the control panel mount is disposed within the second depression in the second operational position.

13. The apparatus of claim 12, wherein the linkage arm includes a hollow passage to permit passage of wiring of the apparatus therethrough.

14. The apparatus of claim 12, wherein the apparatus is a printing apparatus, and wherein the rotatable mount is rotatable about a first axis, the control panel display is rotatable about a second axis orthogonal to the first axis, and the linkage arm is rotatable about a third axis orthogonal to the first axis to permit rotation of the control panel display to a front side of the printing apparatus or a back side of the printing apparatus.

15. The apparatus of claim 12, wherein the rotatable mount includes a third surface orthogonal to the first surface and the second surface, and a fourth surface opposite the third surface and orthogonal to the first surface and the second surface, the third surface including a first hinge pin and the fourth surface including a second hinge pin.
